(19) United States
(12) Patent Application Publication
(10) Pub. No.: US 2010/0205559 A1
(43) Pub. Date: Aug. 12, 2010

(54) QUICK-LAUNCH DESKTOP APPLICATION

(76) Inventor: GREG ROSE, Littleton, CO (US)

Correspondence Address: CARRIE A. BOONE, P.C., 2450 Louisiana, Suite # 400-711, HOUSTON, TX, 77006, US

(21) Appl. No.: 12/703,552

(22) Filed: Feb. 10, 2010

Related U.S. Application Data
(60) Provisional application No. 61/151,821, filed on Feb. 11, 2009.

(51) Int. Cl. G06F 3/048

(52) U.S. Cl. 715/781; 715/835

(57) ABSTRACT

A quick-launch shortcut application is disclosed, enabling a computer user to customize access to commonly used functions. The application enables facile launch of executable programs, web pages, commonly used keystrokes, launches within a launch, and other operations. Users are able to customize the quick-launch application to suit personal preferences.

### TECHNICAL FIELD

This application relates to software applications for simplifying access to commonly used tasks and, more particularly, to software applications accessible from a computer desktop.

### BACKGROUND

Software applications loaded onto a computer enable the computer user to execute them to perform some function. Users often access the applications by selecting one of a list of programs. Microsoft's® Windows® operating system, for example, makes applications loaded onto the computer hard drive available by clicking “start” and “all programs” before being presented with a list of available programs. (Windows is a product of Microsoft Corporation of Redmond, Wash.)

Savvy users will sometimes populate the “desktop,” “dock,” or “home screen” of their computer display with program icons, known as shortcuts. The shortcuts enable the user to open the program directly by clicking on the icon on the desktop, rather than selecting from the operating system-provided list. Apple's® OS X® operating system includes a dock to be populated with frequently used program icons, enabling quick execution of these programs. (OS X is a product of Apple Corporation of Cupertino, Calif.)

Over time, a computer desktop or home screen may become cluttered with these shortcut program icons or the icons may share the desktop with other non-program icons, making quick access to the programs more difficult.

In addition to accessing executable programs, the computer user may frequently perform certain operations, such as invoking a certain keystroke sequence. It is difficult for most users to write a macro or other program that automates these tasks.

Thus, there is a continuing need for a method for quickly accessing programs or other frequently executed operations on a personal computer.

### BRIEF DESCRIPTION OF THE DRAWINGS

The foregoing aspects and many of the attendant advantages of this document will become more readily appreciated as the same becomes better understood by reference to the following detailed description, when taken in conjunction with the accompanying drawings, wherein like reference numerals refer to like parts throughout the various views, unless otherwise specified.

FIG. 1 is a schematic block diagram of a quick-launch shortcut application, according to some embodiments;

FIG. 2 is a block diagram showing how functions defined by the user are scripted and associated with icons by the quick-launch shortcut application of FIG. 1, according to some embodiments;

FIG. 3 is a schematic diagram of the main window appearing upon launch of the quick-launch shortcut application of FIG. 1, according to some embodiments;

FIG. 4 is a schematic diagram of a master window of the quick-launch shortcut application of FIG. 1, according to some embodiments;

FIG. 5 is a second window of the quick-launch shortcut application of FIG. 1, according to some embodiments;

FIG. 6 is a schematic depiction of how a second window is launched from the master window of FIG. 4 using the quick-launch shortcut application of FIG. 1, according to some embodiments;

FIG. 7 is a diagram of an alternative mouser window generated by the quick-launch shortcut application of FIG. 1, according to some embodiments;

FIG. 8 is a diagram of the alternative mouser window of FIG. 7 in which the window is semi-transparent, according to some embodiments;

FIG. 9 is a schematic diagram showing how a default master window is loaded using the quick-launch shortcut application of FIG. 1, according to some embodiments;

FIG. 10 is a schematic diagram of a Windows® desktop showing the drag-and-drop feature of the quick-launch shortcut application of FIG. 1, according to some embodiments;

FIGS. 11A and 11B are schematic diagrams showing how the edit window is used to embed an executable program in the Mouser window of the quick-launch shortcut application of FIG. 1, according to some embodiments;

FIG. 12 is a detailed view of the edit window of the quick-launch shortcut application of FIG. 1, according to some embodiments;

FIG. 13 is a schematic diagram of a macro helper window used to generate macros that are embedded in the Mouser window of the quick-launch shortcut application of FIG. 1, according to some embodiments; and

FIG. 14 is a schematic view of the edit window using the pre-macro window title field of the quick-launch shortcut application of FIG. 1, according to some embodiments.

### DETAILED DESCRIPTION

In accordance with the embodiments described herein, a quick-launch shortcut application is disclosed, enabling a computer user to customize access to commonly used functions. The application enables facile launch of executable programs, commonly used keystrokes, launches within a launch, and other operations. Users are able to customize the quick-launch application to suit personal preferences.

In the following detailed description, reference is made to the accompanying drawings, which show by way of illustration specific embodiments in which the subject matter described herein may be practiced. However, it is to be understood that other embodiments will become apparent to those of ordinary skill in the art upon reading this disclosure. The following detailed description is, therefore, not to be construed in a limiting sense, as the scope of the subject matter is defined by the claims.

In some embodiments, the quick-launch shortcut application is launched by clicking a middle button of a pointing device, known herein as a computer mouse or simply mouse. As such, the quick-launch shortcut application is also known herein as “Mouser”. For those using a mouse without a middle button, the application 100 may be launched by holding down the right mouse button, then clicking the left button while the right button is depressed, then releasing the right button.

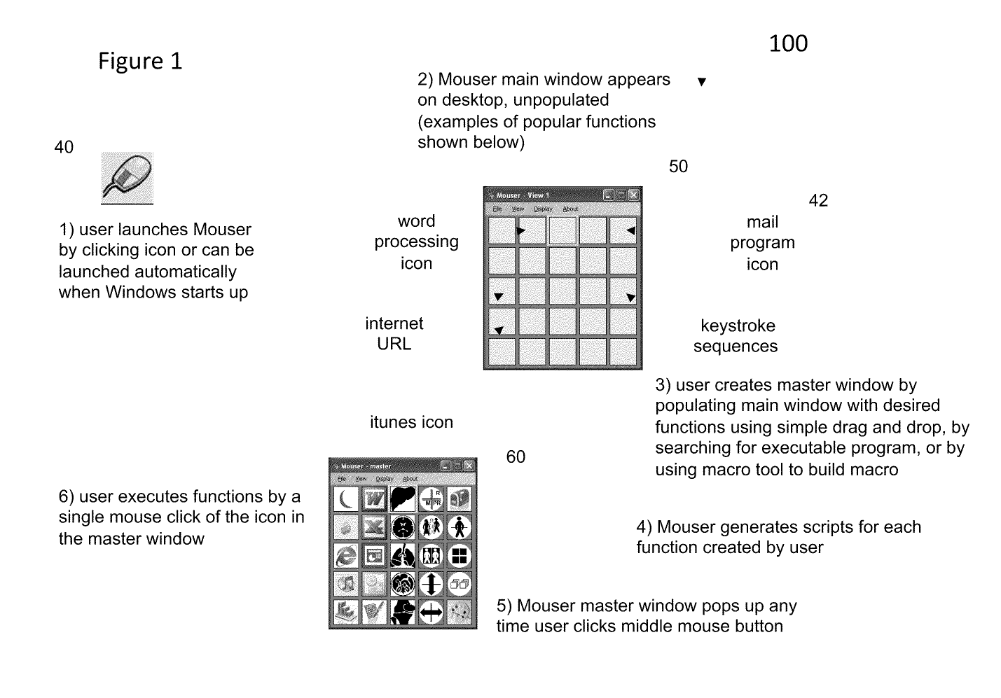

FIG. 1 is a schematic block diagram of a quick-launch shortcut application 100, known herein as Mouser 100, according to some embodiments. The Mouser application 100 is a software program that is associated with and identifiable by a mouse icon 40, as shown. A user launches the Mouser application 100 by clicking on the mouse icon 40. A main window 50, or popup window, appears on the computer desktop. The main window 50 is unpopulated and may be adjusted in shape and size, as described further below. The user populates the main window 50 with icons associated with and representing functions, such as commonly used programs, web page addresses, frequently used keystroke sequences, embedded keystroke operations, and so on, converting the main window (empty) to a master window 60. The Mouser application 100 generates scripts for each function created by the user and associates those scripts with one of the icons. The master window 60 is accessible at any time by clicking on the middle mouser button (default). Thereafter, the user is able to execute programs, macros, etc., by simply clicking on the icons presented in the master window 60. The operations depicted in FIG. 1 are described in more detail, below.

In describing the Mouser application 100, the examples illustrated herein operate under the Microsoft Windows® operating system. However, the Mouser application 100 may be deployed under other operating systems not described herein. Software developers of ordinary skill in the art recognize that, although some of the features of the Mouser application 100 are unique to Microsoft Windows® applications, the features may be nevertheless be present where the application is used with other operating systems, albeit with different visual characteristics. The embodiments described herein are not meant to limit the context or operating system in which the Mouser application 100 may be employed.

Further, in some embodiments, the Mouser application 100 is a file executable on a processor-based system. The processor-based system may be a computer system, such as a desktop computer, a laptop computer, or a server. Alternatively, the Mouser application 100 may be employed in other processor-based devices, such as a personal digital assistant, a cellular phone, a smart phone, a game device, a television, a tablet device, and a variety of other electronic devices in which a processor executes instructions.

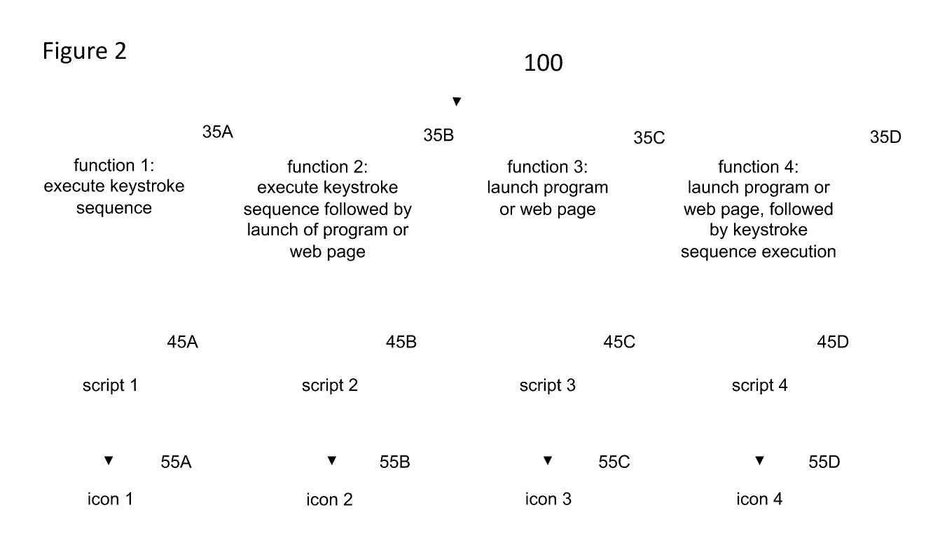

FIG. 2 is a block diagram showing operation of the Mouser application 100, according to some embodiments. The Mouser application 100 makes it easy for the user to create functions that are executed by a simple click of an icon in the master window 60. FIG. 2 depicts four functions 35A, 35B, 35C, and 35D (collectively, “functions 35”) that are created by the user. From these functions 35, the Mouser application 100 generates four scripts 45A, 45B, 45C, and 45D (collectively, “scripts 45”), where each script is associated with its own icon 55A, 55B, 55C, and 55D (collectively, “icons 55”).

In some embodiments, the Mouser application 100 generates the scripts 45 based on the functions 35 desired by the user. The Mouser application 100 also provides an easy-to-use interface that enables the user to generate the functions 35 readily. Where associated icons 55 are already available, as in many executable programs, the Mouser application 100 automatically associates the icon 55 with the program.

Scripting is a mechanism that enables automation of tasks within a processor-based system. Operating systems often have built-in features to enable scripts to be written for the operating system. The Windows operating system, for example, includes a Visual Basic scripting language, VBScript, for writing scripts. VBScript may be used to create applications that run directly on any processor-based system running Microsoft Windows. For each function 35 specified by the user, the Mouser application 100 generates scripts 45 and also associates a unique icon 55 with each script.

When the user selects an icon 55 by clicking thereon with a pointing device, the Mouser application 100 causes the underlying script 45 to be launched. The script may be simple, such as the address to an executable program or web page. Or, the script 45 may launch a series of keystrokes, in the case of macros. Or, the script 45 may perform a combination of keystroke sequences and address access, in the case of combinational operations, such as where a web page or executable program is accessed and certain keystroke operations are to be performed within the web page or program. As used herein, these executable programs, web page addresses, keystroke macros, launches within a program execution, and other user-defined frequently used operations are known as functions 35, or Mouser functions 35.

In FIG. 2, four functions 35 are depicted. In the function 35A, the user requests a simple keystroke sequence to be executed, and will invoke that keystroke sequence by selecting the icon 55A. In the function 35B, the user requests a keystroke sequence execution, followed by the launch of a web page or application program. The function 35B is invoked by selecting the icon 55B in the Mouser window. In the function 35C, a simple launch of a web page or application program is created, with the function 35C being launched by selecting the icon 55C. In the function 35D, a program or web page is launched, followed by the execution of a keystroke combination, when the user selects the icon 55D. The Mouser application 100 may support additional functions not described herein, including, but not limited to, a function that includes a decision tree in which a first action is taken in response to a condition being met while a second action is taken if the condition is not met.

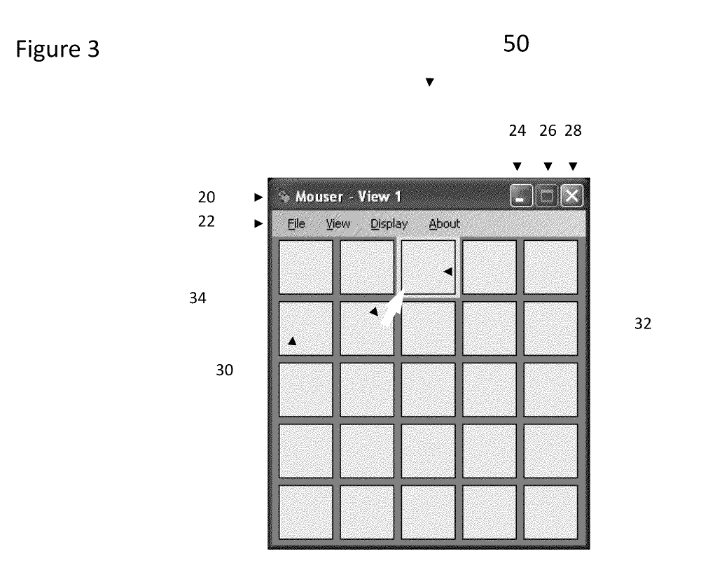

FIG. 3 is a block diagram of the main window 50 for the Mouser application 100, according to some embodiments. The main window 50 denotes that Mouser 100 is a Windows® executable application and thus contains some features commonly found in Windows® applications. The main window 50 includes a header 20, denoting the name of the application and a first view of the application (“Mouser—View 1”). The header 20 also includes two buttons, a minimize button 24 and a close button 28. Standard in Windows® applications, the minimize button 24 allows the user to minimize the main window 50, such that a Mouser 100 icon will appear in the system tray. The close button 28 allows the user to exit the Mouser 100 application. Below the header 20 is a menu bar 22, which includes pull-down menus for various available operations of the main window 50. In FIG. 3, the menu bar 22 includes pull-down menus for “file,” “view,” “display,” and “about.”

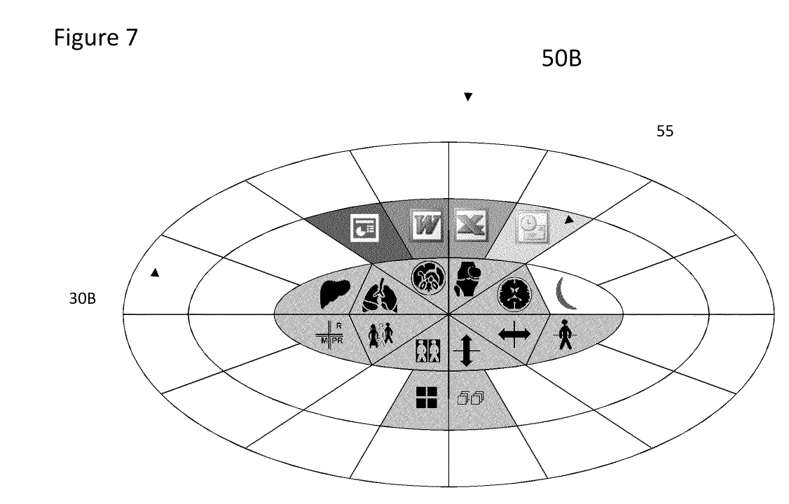

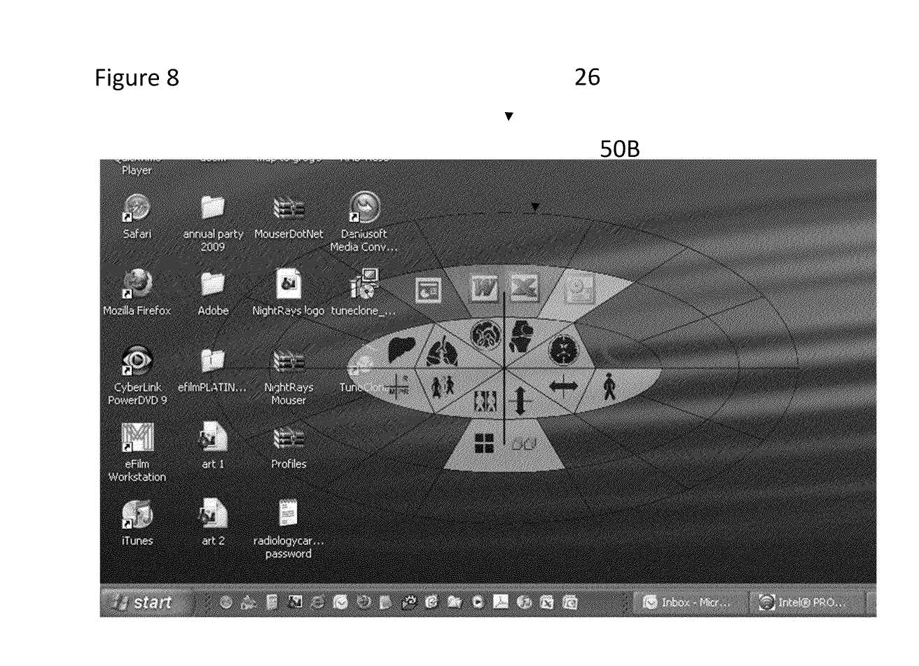

The main window 50 includes twenty-five compartments or squares 30, arranged in a 5×5 grid pattern. The compartments 30 may assume another shape besides being square-shaped, such as in the embodiments of FIGS. 7 and 8, below. In some embodiments, the main window 50 may be customized as to both the number of squares 30 and the arrangement of the squares. Thus, the main window 50 may be a 3×3 grid pattern (nine squares), a 5×3 grid pattern (fifteen squares), a 6×6 grid pattern (36 squares), and so on. When a mouse pointer 34 moves over any of the squares 30, a visual indicator such as a distinct color, surrounds the square, indicating selection of the square. In FIG. 3, the selected square 32 is surrounded by a yellow color. The compartments or squares 30 are to be populated with icons 55 or other visual indicators that are associated with a desired function to be executed by the user, as described below.

In some embodiments, Mouser 100 operates using the following basic navigation. A middle mouse click opens the main window 50 from the minimized state, with the mouse cursor 34 positioned to the center square 30, and the center square shown as selected 32. While the mouse cursor 34 is positioned over a square 30, a left mouse click on that square executes the function 35 (whether it be an executable application, a macro, or other operation) and closes the main window 50. While the mouse cursor 34 is positioned over a square 30, a right mouse click displays available menus in a pull-down fashion familiar to users of the Windows® operating system.

When Mouser 100 is first launched, the main window 50 is a blank slate, enabling the user to populate the squares 30 with icons 55 or other visual indicators (hereinafter, “icons 55”), in which each of the icons is associated with a desired function 35, such as an executable program, a keystroke macro, and so on, as described further below. In some embodiments, the main window 50 is invoked in one of three ways (Windows® operating system only). The main window 50 may be invoked by clicking on the minimized application on the menu bar at startup, by double-clicking on the minimized Mouser 100 icon 40 in the system tray of the user, or by clicking on the middle mouse button. On some mice, the middle mouse button is a roller that may also be clicked as a button.

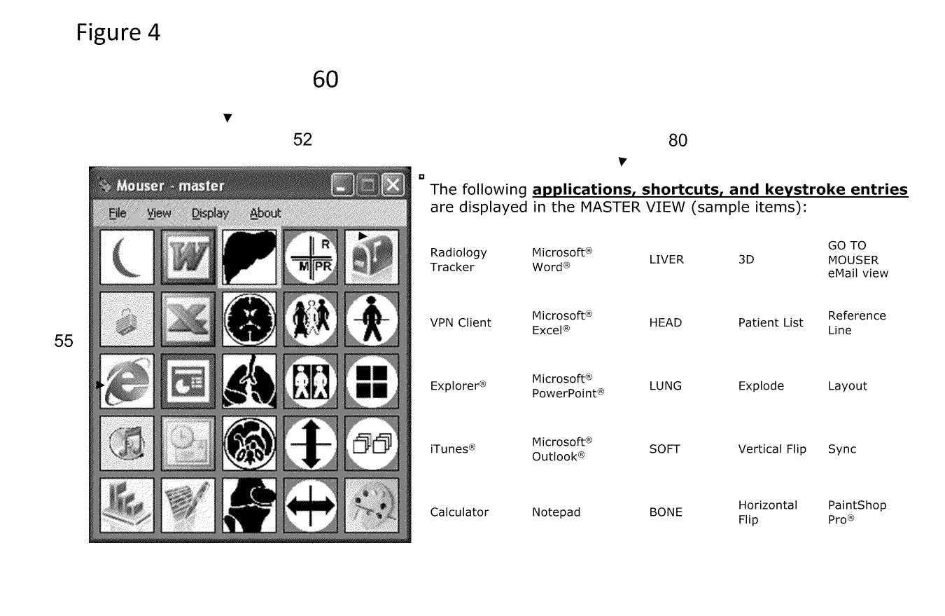

FIG. 4 shows a master window 60 of the mouser application 100, according to some embodiments. As the figure shows, the master window 60 is populated with icons 55, each icon representing a Mouser functions 35 inserted by the user, preferably those functions that are frequently invoked by the user. The master window 60 is adjacent to a description table 80, which describes in words what functions 35 are indicated in the master window 60. Many of the icons 55 are executable program icons, such as for Microsoft® products (Internet Explorer®, Word®, Excel®, Powerpoint®, Outlook®), operating system programs (Calculator, Notepad), other executable programs (ITunes®, PaintShop Pro®). Other icons 55 in FIG. 4 are for custom-made software, in this case, a radiology software application (NightRays® Tracker®) with functions 35 for manipulating radiographic images (liver, head, lung, soft, bone, 3D, patient list, explode, vertical flip, horizontal flip, reference line, layout, sync).

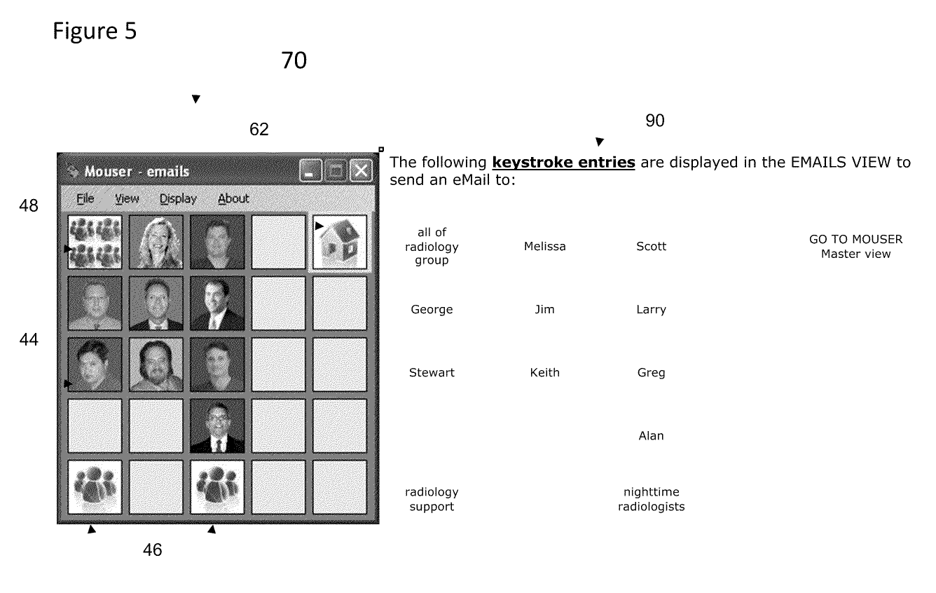

In some embodiments, the Mouser application 100 also enables multiple tiers of compartments to be available for quick access and selection by the user. In FIG. 4, for example, the upper rightmost square 30 includes an icon 52 that looks like a mailbox, with the description table entry, “go to Mouser “email” view.” By selecting the icon 52, a new Mouser window 70 appears, as shown in FIG. 5, according to some embodiments. As used herein any window that includes one or more functions 35 to be executed with a mouse-click, whether it be in a master window or one of its sub-windows is known as a mouser window 50. An associated description window 90 describes the person or persons represented by each icon 55. The emails window 70 is also a 5×5 grid, with some but not all of the squares 30 populated with picture icons 44 and group icons 46, 48. (Alternatively, the squares or other compartments 30 may simply include user names, pictures indicating job descriptions, i.e., dollar sign for accountant, corporate logos, or other indicators, as long as the indicators easily identify individuals within the organization or the functions 35 to be performed when selecting the indicator.) The emails window 70 enables an electronic mail message (email) to be directed to one of the persons depicted in the emails window, with a simple click of the representative icon. In this example, electronic mail messages may be sent to individuals, with each individual having an associated picture icon 44. So, selecting the “Greg” picture icon 44 (center of the email window 70) would cause an email message to open up, with Greg's email address already populating the “to:” line. This simple mouse click on the Greg picture thus eliminates several steps for the user in preparing an electronic mail message to Greg. Electronic mail messages may be sent to an entire organization, by selecting the group icon 48 (all of radiology group). Or, electronic mail messages may be sent to a subset of the entire organization, by selecting the mini-group icon 46 (radiology support or nighttime radiologists).

Also featured in the emails window 70 is an icon 62 that looks like a house. This “home” icon 62, when selected, causes the master window 60 to again appear, replacing the emails window 70. A selection of the email icon 52 in the master window 60 causes the emails window 70 to again appear. The two windows 60, 70 may thus be toggled back and forth as needed.

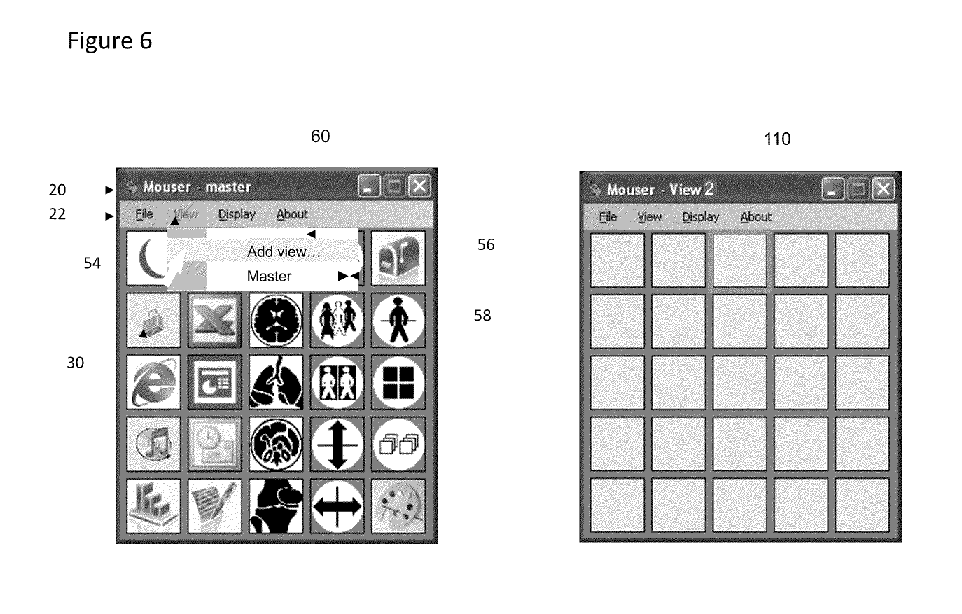

In some embodiments, the master window 60 may also be accessed from the “view” option 54 of the menu bar 22. In FIG. 6, for example, the “view” option 54 includes a pull-down menu 56 that shows the original view (“master”) as well as an option to add a view (“Add view”). When a new view is selected, a new view window 110 appears, showing “view 2” in the header 20. An arrow 58 at the right of the master view also enables another pull-down menu to be selected (not shown). In some embodiments, the additional pull-down menu allows the master view to be either renamed or deleted. Optionally, the mouser application 100 allows the view to be renamed or deleted as well.

This multi-tiered approach may be replicated for other collective functions 35 being performed within an organization. For example, in an organization in which individual spreadsheets, one for each member of the organization are frequently accessed and manipulated, a separate window such as the emails window 70 may be invoked from the master window 60, with each square 30 of the new window being populated with picture icons 44 of each member of the organization. In this example, selecting one of the picture icons would open a spreadsheet for that individual.

FIGS. 7 and 8 show an alternative embodiment of the main window 60 (FIGS. 4 and 6), as mouser window 50B. The mouser window 50B is populated with the same selectable icons 55 of the main window 50, with squares 30B arranged in an oval arrangement. In some embodiments, the mouser window 50B may have a transparent background or may itself be semi-transparent. FIG. 8 shows a desktop 26 with a mouser window 50B located on the desktop. Here, the mouser window 50B is semi-transparent, as other icons on the desktop remain viewable while the mouser window is visible.

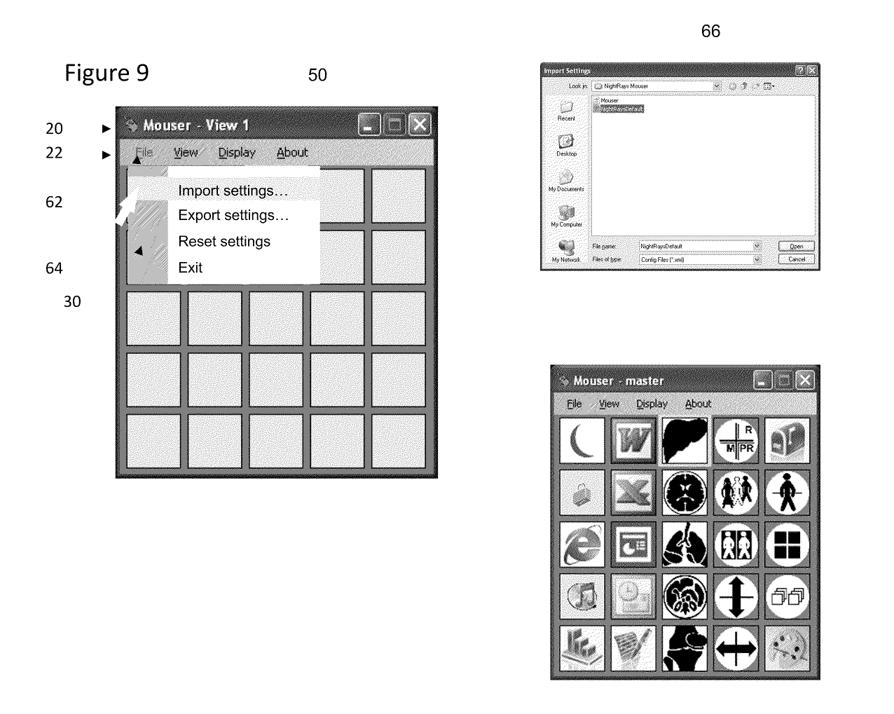

In some embodiments, the Mouser application 100 has default settings for populating the main window 50. Default settings may be established in an organization where multiple members will use the same programs or as a way to populate the squares of the main window 50 with certain predetermined Mouser functions 35, as two examples. FIG. 9 shows an implementation for loading the default master window 60, in one embodiment. By selecting the file menu 62 of the menu bar 22, a pull-down menu 64 appears. The user may select “import settings” from the pull-down menu 64, which causes an “import settings” window 66 to appear. The import settings window 66 may include several default settings that may be selected by the user. In FIG. 9, a single available default setting is shown, the “NightRaysDefault” setting. Once the default setting is selected, the main window 50 (empty) will be replaced with the master window 60 (FIG. 1), with the master window being populated with icons 55 representing the default functions 35.

The Mouser application 100 also allows the entries in the squares 30 to be removed, by resetting the master window 60, such that the master window is restored to the main (empty) window 50. In some embodiments, the file menu 62 of the menu bar 22 has a “reset settings” entry for this purpose.

The pull-down menu 64 of FIG. 9 also has an “export settings” command. The export settings command enables the user to save an .XML file of the mouser window and the associated settings and shortcuts for later retrieval. This .XML file may be send to other members of an organization, enabling the members to share a default Mouser window.

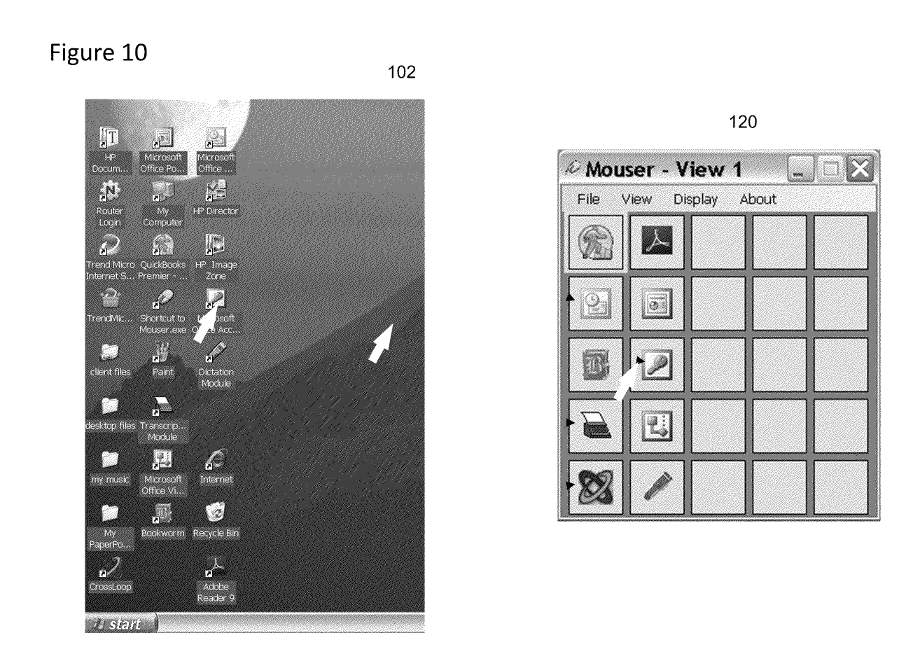

Returning to FIG. 1, the Mouser application 100 enables the user to populate the squares of the empty main view 50 with executable applications, commonly used keystroke sequences, macros, keystroke sequences within launched applications, and other operations, known herein as functions 35 or Mouser functions 35. In some embodiments, the Mouser application 100 enables these operations to be performed by the user in a straightforward manner, with many of the operations being familiar and intuitive to Windows® users. These operations are described in more detail, below.

Where the main window 50 of the Mouser application 100 is populated with icons 55 for executing application programs, the icons are known as shortcuts, since they enable the user to execute the application without going through the preferred operating system sequence, as described in the background section. In some embodiments, the Mouser application 100 enables the main window 50 to be populated with these program icons 55 using a feature known as “drag and drop.” FIG. 10 shows a Windows® desktop 102 having several shortcut icons for executing application programs. The user simply clicks on the desktop icon and, while holding down the mouse button, drags the icon 55 to one of the empty squares 30 and drops the icon into the square by releasing the mouse button until the icon is visible within the main window 120. The Microsoft® Office Access® icon 55 is being dragged over to the main window 120 as shown. Once the icon 55 is present, the Mouser application 100 automatically generates an associated script 45 that includes the address to the Microsoft Access executable program stored on the hard drive or other non-volatile medium of the processor-based system. Subsequently, Microsoft Access is launched by simply clicking on the Access icon in the main window 120. More precisely, once the user clicks on the Microsoft Access icon in the main window 120, the associated script 45 is run automatically, causing Microsoft Access to be launched.

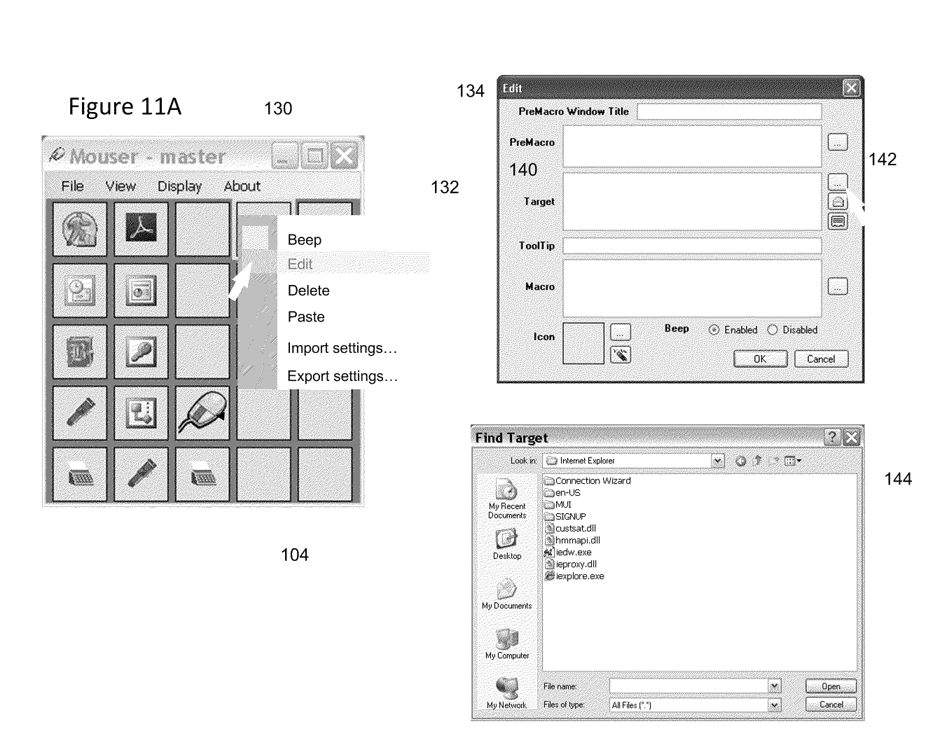

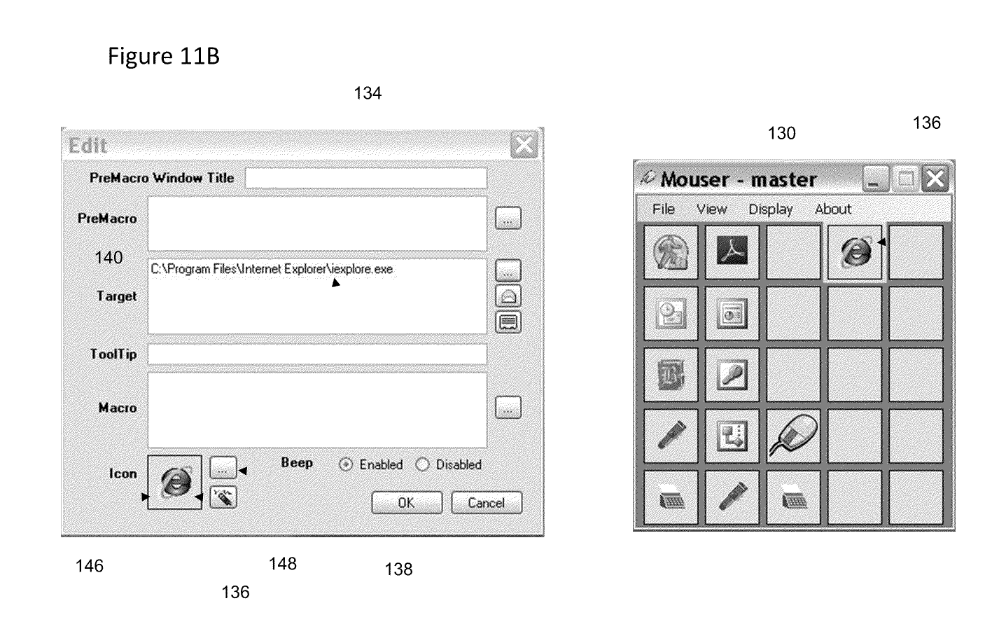

In some circumstances, the icon 55 may not drop into the square 30 of the main window 120. In such a case, the Mouser application 100 has a default icon 55 that will replace the unsuccessful drag-and-drop operation. In FIG. 11A, for example, a default Mouser icon 104 replaces a software program icon 55 that did not get stored in the square 30. Even though the default icon is not the application program icon, clicking on the default icon will nevertheless cause the intended program to be launched, in some embodiments.

In some embodiments, the Mouser application 100 allows executable software programs to be loaded into the main window in other ways besides the drag-and-drop technique. FIGS. 11A and 11B schematically describe a second method available with the Mouser application 100. In FIG. 11A, a master window 130 is shown, populated with several executable program icons 55. Several of the squares 30 in the master window 130 are not filled in. The user may right-click on one of the empty squares 30, causing a pull-down menu 132 which includes an “edit” option. Once the edit option is selected, an edit window 134 appears, as shown in FIG. 11A. The user may click an ellipse button ( . . . ) 142 located to the right of a target field 140 in the edit window 134. This causes a “find target” window 144 to appear. In the example of FIG. 11A, the Internet Explorer executable program (iexplore.exe) is available for selection.

The operations are continued in FIG. 11B. Once the Internet Explorer executable file is selected by the user, an Internet explorer icon 136 appears in the icon box 146 of the edit window 134. (This happens automatically, as the ieexplore.exe file has the Internet Explorer icon 136 embedded within the file.) The target field 140 also shows the address 138 of the executable file. Once the user selects “OK” in the edit window 134, the Internet Explorer icon 136 also appears in the master window 130. As an alternative to selecting the ellipse button 142 to search for the address of the executable file, the Mouser application 100 allows the user to simply type in the address 138 of the executable file by typing the address in the target field 140. Each time the target field 140 (or other fields of the edit window 134) is completed in this way, the Mouser application 100 is automatically generating an associated script file 45 to perform the desired function and the script file 45 is executed once the associated icon 55 is selected by the user.

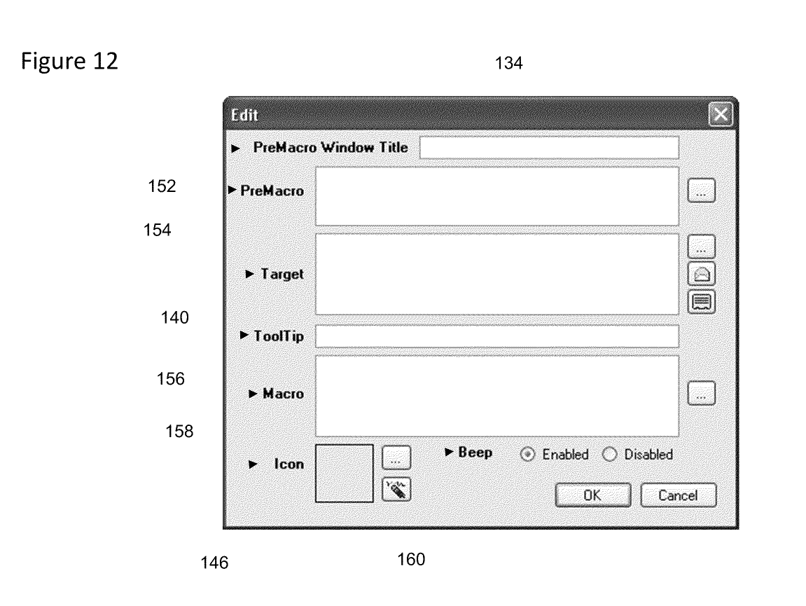

Looking at the edit window 134 more closely, the Mouser application 100 provides several ways in which executable applications may be made available as shortcut icons in its main window 50, as described above. However, the other functions 35 supported by Mouser 100, such as macro operations, keystroke combinations, and keystroke operations within an executed program, are also accessible by using the edit window 134. As indicated in FIG. 12, the edit window 134 includes the following fields: a pre-macro window title field 152, a pre-macro field 154, a target field 140, a tooltip field 156, a macro field 158, an icon field 146, and a beep field 160. Each of these fields is described in more detail below.

From the edit window 134, the target field 140 enables the user to assign information to one of the squares 30 of the mouser window, where the information enables the Mouser application 100 to execute a function 35, as defined above. As shown above, that information may include an address to an executable program. In some embodiments, the Mouser application 100 further allows the target field 140 to be populated with a uniform resource locator (URL) or web page address, an electronic mail address, or a link to another window view (see FIGS. 4 and 5).

In contrast to the example above involving the executable application, the URL does not automatically have an associated icon, so the user may assign an icon 55 to the web address by selecting the ellipse 148 to the right of the icon field 146 and searching for a suitable icon to be associated with the web address. In some embodiments, the icon 55 may be one of several types of digital image files, including, but not limited to, files with the .tiff, .jpg, .giff, .png, .psd, .wmf, .emf, and .bmp extensions.

The Mouser application 100 enables the user to easily insert different types of information by providing an ellipse button 142, an envelope button 162, and an index card button 164. Values are assigned to the square 30 by performing one of the following operations: 1) typing the URL; 2) browsing to an address using the ellipse button 142; 3) inserting an email address using the envelope button 162, inserting another window view using the index card button 164. As shown in FIG. 12, the ellipse button 142, the envelope button 162, and the index card button 164 are adjacent to and thus associated with the target field 140. As with other methods described above, once the target field 140 is completed, the Mouser application 100 automatically generates a script 45 and associates that script with the icon 55 so that the desired function is performed when the user selects the icon.

Similarly, the macro field 158 enables the user to assign information to one of the squares 30 of the mouser window, where the assigned information facilitates the execution of a function 35. However, the information entered into the macro field 158 is executed after the information entered in the target field 140. In this instance, the function 35 is made up of the execution of the application program, plus the execution of the predefined macro sequences. As with executable programs and web pages, this newly defined function 35 will have an associated icon 55 or other visual indicator that may be defined by the user. This enables commonly used keystroke combinations within an application to be executed by simply clicking on the square that features the newly defined function icon 55, causing the application to be launched, then the keystroke sequence(s) to be performed automatically.

Suppose, for example, the user commonly accesses a website that requires an email address prior to entry. The web address or URL would be typed into the target field 140. Then, the user might have a sequence of macro commands as follows:

{PAUSE 4000}{TAB9}{yourname@emailaddress.com}

The {PAUSE4000} command tells the Mouser application 100 to pause four seconds before executing the next command. Since the URL of the website in the target field 140 is executed before the macro commands, the {PAUSE4000} command allows four seconds to pass, which should be sufficient time for the URL to be loaded. The determination of how many seconds should pass before the subsequent macro command is executed may be determined empirically, as loading time, internet connection speed, and other factors will affect how fast a program or web page will load on any given computing device.

The {TAB9} command tells the Mouser application 100 to tab nine times before executing the next command. Again, this is a macro command to be empirically determined. For some URLs, the email address is entered at the first tab, so {TAB1} would be used instead. Since the next command is the email address of the user, the tab macro command is based on the number of tabs it takes on the web page to get to the email address field. Since web pages and application programs vary widely in their implementation details, it may take some trial and error for the user to determine the exact number of tabs needed for each shortcut. Nevertheless, the edit window 134 of the Mouser application 100 provides a facile mechanism by which the user enters macros, keystroke combinations, and other function information.

The last macro command, {yourname@emailaddress.com}, tells the Mouser application 100 to enter yourname@emailaddress.com into the ninth tab location of the URL in the target field 140 after four seconds have elapsed, enough time for the URL to launch.

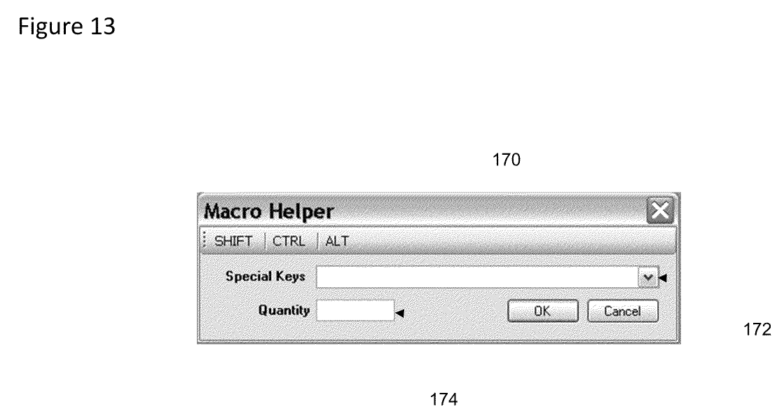

The mouser application 100 also provides for keystroke sequences that are to take place prior to the execution of a program or web page. The pre-macro field 154 is used for those keystroke operations that need to be executed prior to the executable program or URL that is in the target field 140. Both the pre-macro field 154 and the macro field 158 have an associated macro helper button 166, 168, which, when selected, open a macro helper window 170, as shown in FIG. 13. Using the macro helper window 170, the user may enter key combinations including a shift (SHIFT), control (CTRL), or alt (ALT) key. The macro helper window 170 also enables the user to select special keys from a drop-down menu 172. In some embodiments, the available special keys include backspace, break, caps lock delete, down arrow, end, enter, escape, help, home, insert, left arrow, num lock, page down, page up, pause, print screen, right arrow, scroll lock, tab, up arrow, and function keys F1-F16. A quantity field 174 enables the user to denote the number of times the selected key is to be invoked.

The beep field 160 of the edit window 134 (FIG. 12) enables the user to determine whether audible sounds are heard when a square 30 in the mouser window 50 is executed or not. The tool tip field 156 enables the user to enter text that will be displayed whenever the user moves the mouse pointer over the associated square 30. Particularly for functions 35 where the icon 55 in the square 30 is unfamiliar or where keystroke combinations are invoked, the tool tip field 156 facilitates ease of use by clarifying the purpose of the square 30. The icon field 146 enables the user to change the icon 55 associated with the command. The icon field 146 has two associated buttons, the ellipse button 176 enables the user to browse to find another icon 55, while the erase button 178 enables the user to remove the icon from the square 30.

In some embodiments, the pre-macro window title field 152 is an advanced feature of the Mouser application 100. Preferably, the pre-macro window title field 152 is filled in only when the user is setting up a keystroke command for use in a particular application when that application is not the last current window. Some applications, such as EFilmWorkstation® have multiple windows open and the focus is changed between those windows as the user is navigating through the application. If the user sends a command to another application that was not the most recently accessed window or application, such as Microsoft Word, the user may employ the pre-macro title field 152 to solve this problem.

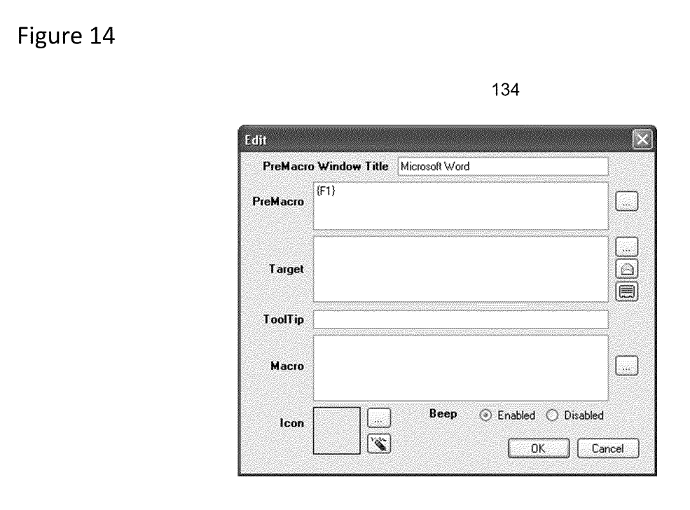

For example suppose the user has Microsoft Word®, Microsoft Internet Explorer®, and Firefox® opened simultaneously. The user desires to have one of the squares 30 of his main window 50 defined to open the help file within Microsoft Word®, which is normally done by selecting the F1 key while in Word. The Mouser application 100 automates this operation using the edit window 134 shown in FIG. 14. If the user invokes the Mouser command defined by the edit window 134 in FIG. 12 while Firefox® is opened and active and Word is opened but not the most recently accessed window, the pre-macro window title field 152 ensures that the requested command (the F1 key) is sent to Microsoft Word (the minimized window) instead of being sent to Firefox®, the maximized and last used window.

When there are two Microsoft® Word® windows opened simultaneously, such as two open documents, Windows will select one of the two windows arbitrarily, since the pre-macro title field 152 does not specify one of the two windows. Thus, preferably, the user exercises care when using the pre-macro title field 152.

In some embodiments, the Mouser application 100 has a number of advantages over a separate keypad. The mouser window 50 takes up no space on the user's desktop, and is automatically minimized after use. The Mouser application 100 less costly than the cost of a separate hardware keypad. The appearance and function of the Mouser buttons are easily changed by performing drag and drop operations, as described below, whereas a keypad implementation requires re-printing the icon 55. Further, when the user wants to perform an operation from the keypad, he takes his hand off the mouse, looks away from the screen, finds the correct button on the keypad, selects the key, puts his hand back on the mouse, and looks back at the screen. By contrast, with the Mouser application 100, the user is able to maintain his hand position on the mouse and eyes on the screen, since the mouser window 50 appears at the position of the mouse pointer. The setting of the Mouser application 100 are easily copied to other computers and the settings can be universally changed.

In contrast to prior art solutions, the Mouser application 100 is intuitive for even unsophisticated users. The Mouser window 50 is quickly accessible by touching the mouse and the window appears immediately under the mouse pointer. The drag-and-drop feature for populating compartments 30 with program icons is easy to use, but the Mouser application 100 is further enhanced with a straightforward edit window 134 and macro helper window 170 to enable the user to define keystroke combinations to be executed along with an application program or web page. Buttons on the edit window 134 make browsing and email operations easy to engage. The Mouser window may be ever-present on the user's desktop, may be invoked and available when the processor-based system is turned on, may be minimized but quickly accessible when not being used (with the middle mouse button invoking it by default), may be transparent, may be square in shape or assume some other shape. One or more predefined mouser windows may be stored in an XML file and distributed to several members of an organization.

While the application has been described with respect to a limited number of embodiments, those skilled in the art will appreciate numerous modifications and variations therefrom. It is intended that the appended claims cover all such modifications and variations as fall within the true spirit and scope of the invention.

1. A quick-launch shortcut application, comprising:
a window to be presented to a video display of a processor-based system using a pointing device, the window comprising a plurality of compartments, each compartment to be populated with a different icon of a plurality of icons, wherein one of the plurality of icons is associated with a function to be executed on the processor-based system; and
a script describing the function to be executed on the processor-based system, wherein the script is executed by an operating system running on the processor-based system;
wherein the function is executed by selecting the icon representing the function from within the window.

2. The quick-launch shortcut application of claim 1, wherein the compartments are squares and the window comprises twenty-five squares arranged in a 5×5 configuration.

3. The quick-launch shortcut application of claim 1, wherein the icon represents a function to open a second window, the second window comprising a second plurality of compartments, each to be populated with a second plurality of functions to be executed on the processor-based system.

4. The quick-launch shortcut application of claim 1, wherein the window is launched by clicking a middle button of the pointing device.

5. The quick-launch shortcut application of claim 1, wherein the window is launched by holding down a right button of the pointing device, then clicking a left button of the pointing device while the right button is depressed, then releasing the right button.

6. The quick-launch shortcut application of claim 1, wherein the function is selected from a group consisting of an executable program, a web page address, a macro, an executable program followed by a macro, an executable program preceded by a macro, a web page address followed by a macro, and a web page address preceded by a macro.

7. The quick-launch shortcut application of claim 1, wherein the window is saved as a default window.

8. The quick-launch shortcut application of claim 3, wherein the second window is generated by adding a view from a view menu.

9. The quick-launch shortcut application of claim 1, wherein the window is oval-shaped.

10. The quick-launch shortcut application of claim 1, wherein the window is semi-transparent.

11. The quick-launch shortcut application of claim 7, wherein the default window is retrieved using an import option.

12. The quick-launch shortcut application of claim 1, wherein one of the plurality of compartments is populated with a second icon by dragging the second icon from a desktop of the processor-based system to the compartment.

13. The quick-launch shortcut application of claim 1, further comprising an edit window to associated the icon with the function.

14. The quick-launch shortcut application of claim 13, wherein one of the plurality of compartments is populated with a second icon by browsing to find an address of an executable application and storing the address in the edit window, the second icon automatically being associated with the executable application.

15. The quick-launch shortcut application of claim 13, wherein one of the plurality of compartments is populated with a third icon by entering a uniform resource locator in the edit window, the third icon being a default icon.

16. The quick-launch shortcut application of claim 13, wherein one of the plurality of compartments is populated with an icon representing an electronic mail address and storing the electronic mail address in the edit window.

17. The quick-launch shortcut application of claim 13, further comprising a macro helper window to enable key combinations, including shift, control, alt, and/or special keys, as well as multiples of key combinations, to be entered into the edit window as a macro.

18. The quick-launch shortcut application of claim 13, further comprising a pre-macro field and a target field in the edit window, wherein the pre-macro field is used to specify one or more keystroke operations to be performed prior to execution of the address stored in the target field, wherein the address indicates either a location of an executable program or a web page address.

19. A method, comprising:
launching a window onto a video display of processor-based system, the window comprising a plurality of compartments, each compartment to be populated with a different icon, wherein one of the icons represents a function to be executed on the processor-based system; and
generating a script of a function on the processor-based system, wherein the script is associated with the icon;
wherein the function is executed when the icon is selected.

20. The method of claim 19, further comprising:
populating one of the plurality of compartments with a second icon representing an executable program by dragging the second icon from a desktop of the processor-based system into the compartment, wherein a second script denoting the physical address of the executable program is automatically generated when the second icon is dragged into the compartment.

21. The method of claim 19, further comprising:
opening an edit window comprising a target field and an icon field;
entering a uniform resource locator representing a second function in the target field such that a second script of the uniform resource locator is automatically generated; and
browsing the processor-based system for a digital image file to store in the icon field, the digital image file to generate a second icon, wherein the second icon is associated with the second script;
wherein the second function is executed when the second icon is selected.

22. The method of claim 19, further comprising:
opening an edit window comprising a pre-macro field and an icon field;
entering one or more keystrokes representing a second function in the pre-macro field such that a second script of the one or more keystrokes is automatically generated; and
browsing the processor-based system for a digital image file to store in the icon field, the digital image file to generate a second icon, wherein the second icon is associated with the second script;
wherein the second function is executed when the second icon is selected.

23. The method of claim 19, further comprising:
opening an edit window comprising a macro field and an icon field;
entering one or more keystrokes representing a second function in the macro field such that a second script of the one or more keystrokes is automatically generated; and
browsing the processor-based system for a digital image file to store in the icon field, the digital image file to generate a second icon, wherein the second icon is associated with the second script;
wherein the second function is executed when the second icon is selected.

24. The method of claim 22, further comprising:
populating a target field of the edit window with an address of an executable file, wherein the executable file is stored on a non-volatile medium of the processor-based system;
wherein the second function comprises the execution of the one or more keystrokes followed by the launch of the executable file.

25. The method of claim 23, further comprising:
populating a target field of the edit window with an address of an executable file, wherein the executable file is stored on a non-volatile medium of the processor-based system;
wherein the second function comprises the launch of the executable file followed by the execution of the one or more keystrokes.

26. The method of claim 22, further comprising:
populating a target field of the edit window with a uniform resource locator address, wherein the uniform resource locator address is an address to a web page;
wherein the second function comprises the execution of the one or more keystrokes followed by the launch of the web page.

27. The method of claim 23, further comprising:
populating a target field of the edit window with a web page address;
wherein the second function comprises the launch of the web page followed by the execution of the one or more keystrokes.
